(19) United States
(12) Patent Application Publication
(10) Pub. No.: US 2010/0056965 A1
(43) Pub. Date: Mar. 4, 2010

(54) OSCILLATING MECHANISM

(76) Inventor: Don-Lon Yeh, Taichung City (TW)

Correspondence Address: Chien-Hui Su, P. O. Box 70-121 Taichung, Taichung City, 40899, TW

(21) Appl. No.: 12/202,434

(22) Filed: Sep. 2, 2008

(51) Int. Cl. A61H 15/00; A61H 1/00

(52) U.S. Cl. 601/94; 601/90; 310/80

(57) ABSTRACT

An oscillating mechanism includes a motor, a speed reduction assembly, a transporting assembly, and a linking base. The motor operated in a rotational reciprocating motion. The speed reduction assembly is connected to the motor and driven by the motor. The transporting assembly is connected to the speed reduction assembly. The transporting assembly includes a conveyer belt wound around two rollers. One of the two rollers is driven by the speed reduction assembly. The linking base is mounted on the conveyer belt and driven by the conveyer belt to move between the two rollers. A bed is connected to the linking base and moves in a linear reciprocating motion to provide the effort of whole body massage.

### BACKGROUND OF THE INVENTION

1. Field of the Invention

The present invention relates to an oscillating mechanism, and more particularly to an oscillating mechanism provided for a pad.

2. Description of Related Art

A conventional pad for nursing in accordance with the prior art comprises a massage mechanism connected thereto. The pad is used as a seat cushion or a mattress. The massage mechanism includes a transmission device and multiple linkages. The multiple linkages are used to pat the body for providing the effort of massage to avoid the pathological changes which are caused by the pressure acting on the patient when sitting on the chair or lying on the bed over a long period of time. However, the massage is limited on a small range of body. The more linkages are needed to cover more ranges for messages. Therefore the massage mechanism is more complicated. Besides, the ranges for messages do not cover the whole body so that the effort of massage is limited.

The present invention has arisen to mitigate and/or obviate the disadvantages of the conventional pad with a massage mechanism.

### SUMMARY OF THE INVENTION

The main objective of the present invention is to provide an improved oscillating mechanism provided for a pad, in that an oscillating mechanism with a simple structure for whole body massage is acquired.

To achieve the objective, the oscillating mechanism includes a motor, a speed reduction assembly, a transporting assembly, and a linking base. The motor operated in a rotational reciprocating motion. The speed reduction assembly is connected to the motor and driven by the motor. The transporting assembly is connected to the speed reduction assembly. The transporting assembly includes a conveyer belt wound around two rollers. One of the two rollers is driven by the speed reduction assembly. The linking base is mounted on the conveyer belt and driven by the conveyer belt to move between the two rollers. A carrier base is mounted on the linking base and driven by the linking base. A bed is mounted on the carrier base and moves with the carrier base. Therefore the bed moves in a linear reciprocating motion to provide the effort of whole body massage.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of an oscillating mechanism in accordance with the present invention;

FIG. 2 is a schematic side plane view of the oscillating mechanism in accordance with the present invention when being mounted to a frame;

FIGS. 3 and 4 are the operational side plane views of the oscillating mechanism in accordance with the present invention;

FIG. 5 is a partial exploded perspective schematic view of the oscillating mechanism adapted to a bed in accordance with the present invention; and

FIG. 6 is a side plane view of the oscillating mechanism in FIG. 5.

### DETAILED DESCRIPTION OF THE INVENTION

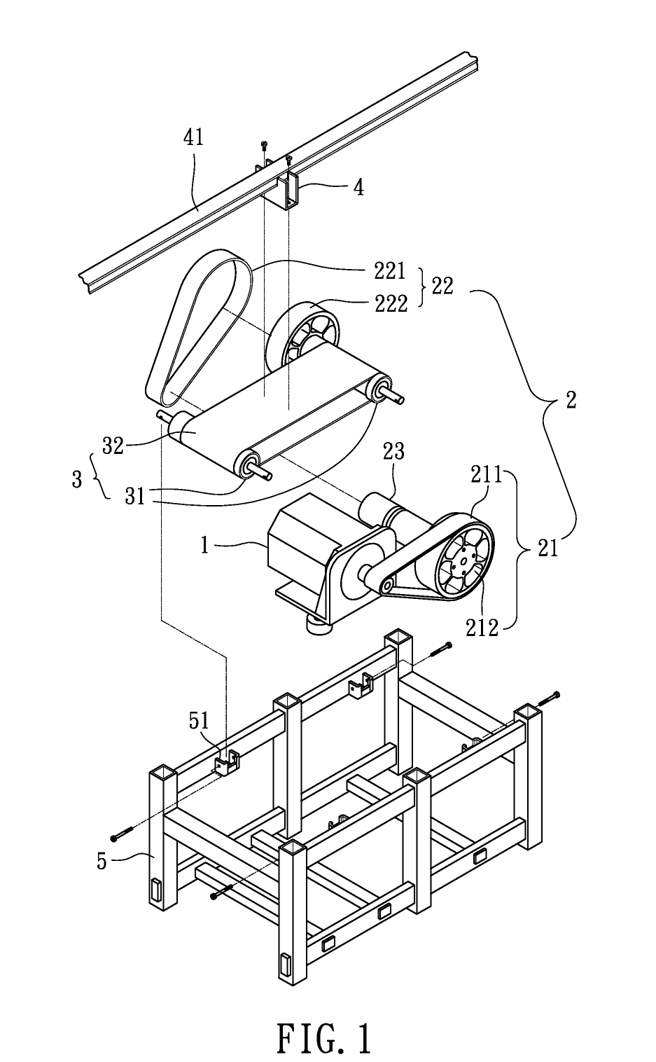

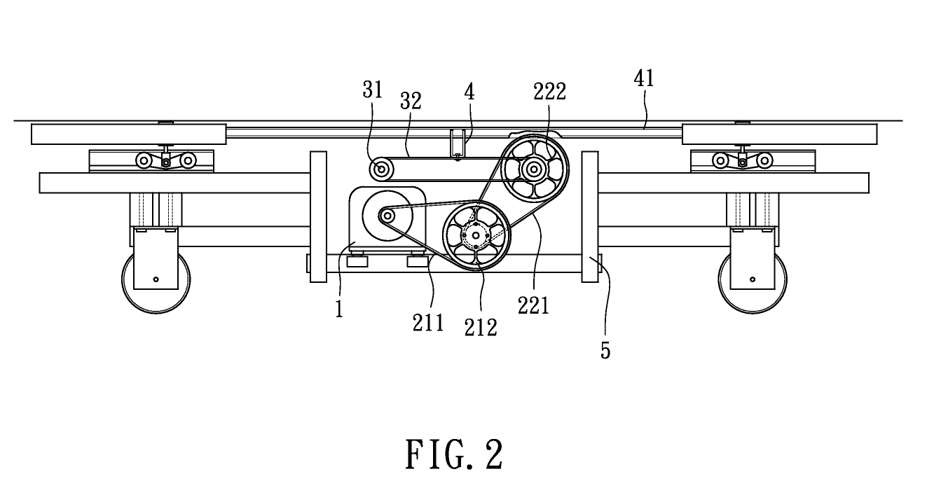

Referring to the drawings and initially to FIGS. 1-2, an oscillating mechanism provided for a pad in accordance with the present invention comprises a base 5, a motor 1 fixed on the base 5, a speed reduction assembly 2 connected to the motor 1, a transporting assembly 3 connected to the speed reduction assembly 2, and a linking base 4 connected to the transporting assembly 3.

The motor 1 is operated in a rotational reciprocating motion.

The speed reduction assembly 2 includes a first speed reduction mechanism 21 connected to the motor 1, a spindle 23 connected to the first speed reduction mechanism 21, and a second speed reduction mechanism 22 connected to the spindle 23. The first speed reduction mechanism 21 includes a first belt 211 wound around a motor spindle (not numbered) and a first rotor 212 to drive the first rotor 212, wherein the spindle 23 is coaxially mounted with the first rotor 212 such that the spindle 23 rotationally synchronizes with the first rotor 212. The spindle 23 and the first rotor 212 are pivotally mounted on the base 5. The second speed reduction mechanism 22 includes a second belt 221 wound around the spindle 23 and a second rotor 222 to drive the second rotor 222 which is pivotally mounted on the base 5. The motor spindle is diametrically smaller than the first rotor 212. The spindle 23 is diametrically smaller than the first rotor 212 and the second rotor 222.

The transporting assembly 3 includes two rollers 31 and a conveyer belt 32 wound around the two rollers 31. One of the two rollers 31 is coaxially mounted with the second rotor 222. The two rollers 31 are diametrically smaller than the second rotor 222. The linking base 4 is fastened on the conveyer belt 32. The motor 1 and the speed reduction assembly 2 are mounted on the base 5 to stabilize the movement of the motor 1 and the speed reduction assembly 2. The base 5 has two pairs of brackets 51 mounted thereon. Each pair of brackets 51 is provided to support a corresponding one of the two rollers 3 1.

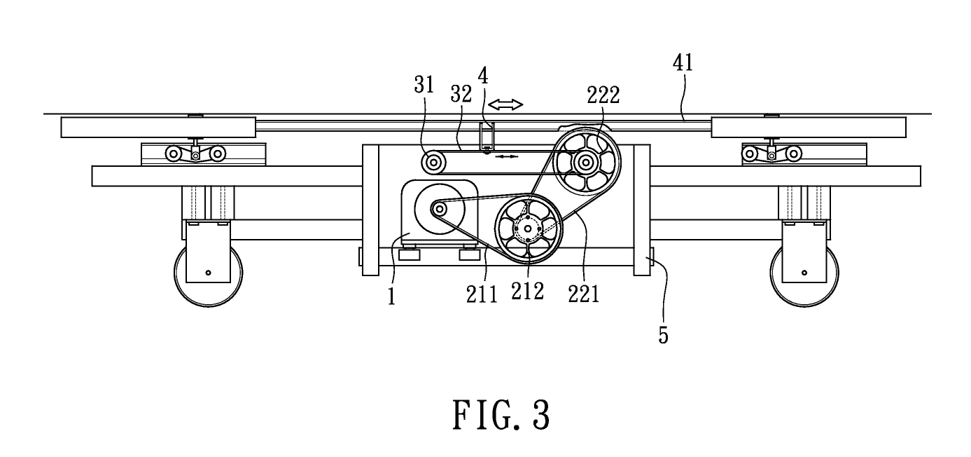

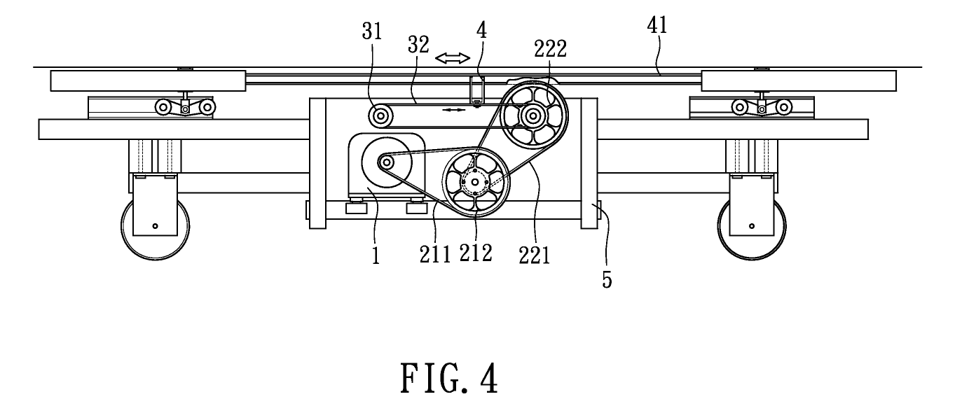

Referring to FIGS. 3 and 4, the operation of the oscillating mechanism in accordance with the present invention is shown. When the motor 1 is operated in the rotational reciprocating motion, the first rotor 212 and the spindle 23 are driven via the first belt 211. In the meantime, the second rotor 222 and one of the rollers 31 mounted with the second rotor 222 are driven via the second belt 221 such that the conveyer belt 32 is driven to move in a linear reciprocating motion. Therefore, the linking base 4 also moves with the conveyer belt 32 in the linear reciprocating motion between the two rollers 31.

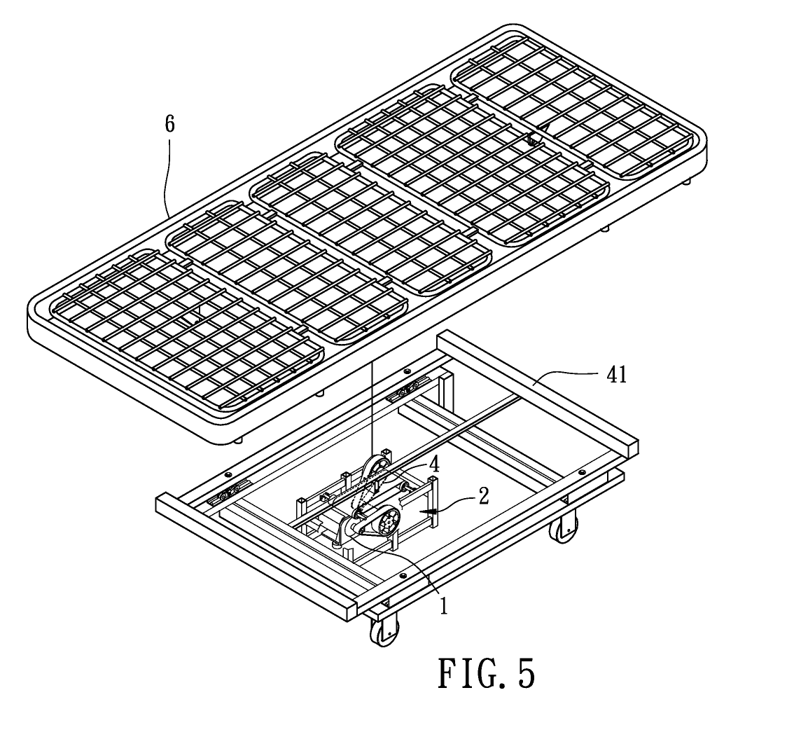

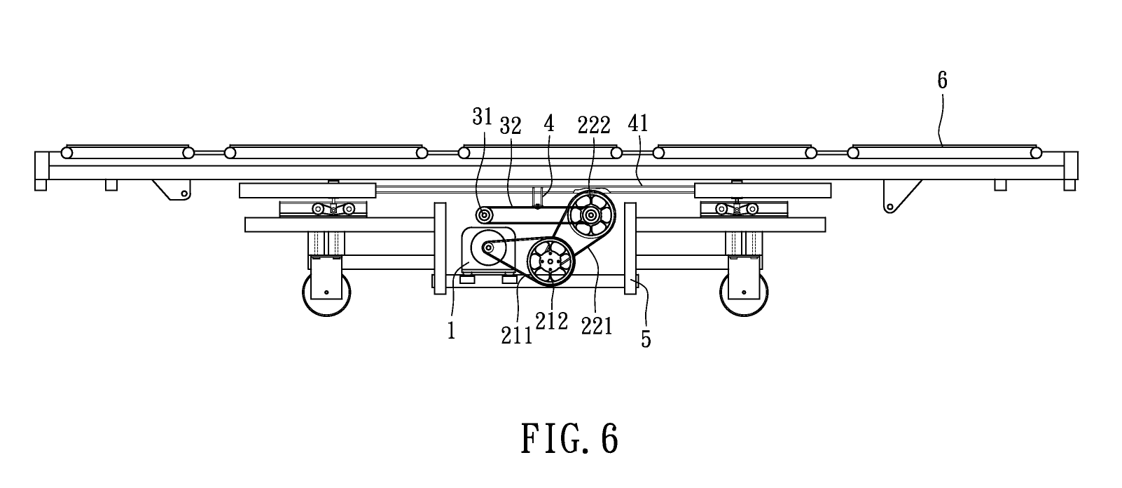

Referring to FIGS. 5 and 6, the oscillating mechanism in accordance with the present invention is adapted to oscillate a pad. In the FIG. 5 the pad is used as a mattress 6. In addition, the pad also can be used as a seat cushion. A carrier base 41 is mounted on the linking base 4 and moves with the linking base 4. The mattress 6 is mounted on the carrier base 41 and moves with the carrier base 41. Therefore the mattress 6 moves with the linking base 4 in the linear reciprocating motion to stimulate the twelve meridians in the body for promoting blood circulation.

The speed reduction assembly 2 also provides the effort of increasing the loading torque due to ratio of diameter. A ratio of diameter between the first rotor 212 and the motor spindle is greater than one. A ratio of diameter between the second rotor 222 and the spindle 23 is also greater than one. Therefore the loading torque is high enough to move the body on the pad. Additionally, the ratio of diameter can be changed to fit the different body weight.

Although the invention has been explained in relation to its preferred embodiment, it is to be understood that many other possible modifications and variations can be made without departing from the spirit and scope of the invention as hereinafter claimed.

What is claimed is:

1. An oscillating mechanism comprising:
a motor operated in a rotational reciprocating motion;
a speed reduction assembly connected to the motor and driven by the motor;
a transporting assembly connected to the speed reduction assembly, the transporting assembly having a conveyer belt wound around two rollers, one of the two rollers driven by the speed reduction assembly; and
a linking base mounted on the conveyer belt and driven by the conveyer belt to move between the two rollers.

2. The oscillating mechanism as claimed in claim 1, wherein the speed reduction assembly comprises a first speed reduction mechanism, a spindle connected to the first speed reduction mechanism, and a second speed reduction mechanism connected to the spindle, the first speed reduction mechanism having a first belt wound around a motor spindle and a first rotor, the spindle coaxially connected to the first rotor, the second speed reduction mechanism having a second belt wound around the spindle and a second rotor, one of the two rollers coaxially connected to the second rotor, the first rotor being diametrically larger than the motor spindle and the spindle, the second rotor being diametrically larger than the spindle and the two rollers.

3. The oscillating mechanism as claimed in claim 1 further comprising a base, the motor and the speed reduction assembly mounted on the base, the base having two pairs of brackets mounted thereon, each pair of brackets corresponding one of the two rollers to support the corresponding roller.

4. The oscillating mechanism as claimed in claim 2 further comprising a base, the motor and the speed reduction assembly mounted on the base, the base having two pairs of brackets mounted thereon, each pair of brackets corresponding one of the two rollers to support the corresponding roller.

5. A bed with an oscillating mechanism, comprising:
a motor operated in a rotational reciprocating motion;
a speed reduction assembly connected to the motor and driven by the motor;
a transporting assembly connected to the speed reduction assembly, the transporting assembly having a conveyer belt wound around two rollers, one of the two rollers driven by the speed reduction assembly;
a linking base mounted on the conveyer belt and driven by the conveyer belt to move between the two rollers;
a carrier base mounted on the linking base; and
a mattress mounted on the carrier base.

6. The bed with the oscillating mechanism as claimed in claim 5, wherein the speed reduction assembly comprises a first speed reduction mechanism, a spindle connected to the first speed reduction mechanism, and a second speed reduction mechanism connected to the spindle, the first speed reduction mechanism having a first belt wound around a motor spindle and a first rotor, the spindle coaxially connected to the first rotor, the second speed reduction mechanism having a second belt wound around the spindle and a second rotor, one of the two rollers coaxially connected to the second rotor, the first rotor being diametrically larger than the motor spindle and the spindle, the second rotor being diametrically larger than the spindle and the two rollers.

7. The bed with the oscillating mechanism as claimed in claim 5 further comprising a base, the motor and the speed reduction assembly mounted on the base, the base having two pairs of brackets mounted thereon, each pair of brackets corresponding one of the two rollers to support the corresponding roller.

8. The bed with the oscillating mechanism as claimed in claim 6 further comprising a base, the motor and the speed reduction assembly mounted on the base, the base having two pairs of brackets mounted thereon, each pair of brackets corresponding one of the two rollers to support the corresponding roller.
